(19) United States
(12) Patent Application Publication
(10) Pub. No.: US 2010/0251292 A1
(43) Pub. Date: Sep. 30, 2010

(54) Smartphone for interactive television

(76) Inventors: Sudharshan Srinivasan, Fremont, CA (US); Kothandraman Ramchandran, Fremont, CA (US); Jai Kumar, Cupertino, CA (US)

Correspondence Address: SUDHARSHAN SRINIVASAN, 5496 GOLUBIN COMMON, FREMONT, CA, 94555, US

(21) Appl. No.: 12/383,607

(22) Filed: Mar. 27, 2009

(51) Int. Cl. H04N 5/445; H04N 7/16; H04N 7/173; H04H 40/00

(52) U.S. Cl. 725/37; 725/153; 725/132; 725/62; 455/3.06

(57) ABSTRACT

A mobile device (34) capable of processing real time broadcast television signals (36) is described. Television signals (36) are received by mobile device (34) and converted to desired digital video content (47) format and then combined with output of software applications (43) running at mobile device (34) to create a combined television signal (51) that can be displayed by a television (37). Combined television signal is sent to television (37) to enable a user (48) to interact with television content using software applications (43) executing at mobile device (34).

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to interactive television and specifically the use of smartphone software and hardware to enable interactive television that supports mobility.

2. Prior Art US Patent

Interactive television enables television viewers to interact with content being shown. This is usually accomplished using a set top box attached to a television. The set top box intercepts television video signals and combines these video signals with output of software programs running at the set top box and then outputs the combined signal into a television. The set top box also enables receiving input from a user using a remote control to operate upon the combined signal consisting of video signal and output of software programs. Having the ability to view and interact with output of software programs alongside video signals enables programmable user interaction with television content thus providing an interactive television system.

Newer generation televisions have advanced micro-processors built into them, serving as a replacement for the set top box. Henceforth both these solutions shall be considered equivalent in subsequent descriptions and the term set top box shall refer to both solutions.

Set top boxes contain advanced microprocessors capable of running advanced software programs. But all these software programs are limited to providing services only when a viewer is in proximity to the television. A user cannot continue using services of such software programs when he/she is mobile.

Mobility of interactive television software is important when users would like to continue operating software associated with video content beyond their proximity to a television. The problem of mobility is particularly emphasized when interactive television software gets complex with large amounts of internal software state.

Interactive television software can range from supporting simple operations such as recording parts of a program to advanced communication software enabling multi-party communication across the internet related to the video content being viewed.

As microprocessors in set top boxes get more advanced, the complexity of associated software programs is ever increasing. This leads to complex internal state of software programs. Copying internal state of such software programs or sharing such state with external devices becomes infeasible and hence cannot be relied upon for a mobile solution. Only simple operations such as copying parts of recorded data from the set top box into a mobile device may be supported, but synchronizing complex runtime state data such as in a multi-user communication session across a set top box and a mobile device is not feasible.

There are solutions that offer copying content from a set top box into mobile devices but there are no solutions that provide for sharing applications and corresponding application software states across mobile devices and set top boxes.

Sharing applications and corresponding states across mobile devices is necessary in many usage scenarios of interactive television. As an example, a user may be viewing a television program where a web URL (universal resource locator) may be displayed, and the viewer may want to copy this URL as a bookmark into a browser for future use. If the browser was a software application at the set top box, and the user wanted this URL to be available in a mobile device too, then the user would have to manually copy this URL into his/her mobile device as an additional step, since synchronizing bookmarks across a browser of the set top box and a browser of the mobile device is not an easy task.

Similarly, if a user is engaged in an instant messaging session with another user regarding some content being viewed, the user would have to disconnect his/her session when the user becomes mobile and restart another session, resulting in loss of all prior communication context that a user had established while communicating using a set top box.

Hence it can be seen that copying parts of data or parts of application state from a set top box into a mobile device is insufficient to provide seamless mobility of applications.

Hence it can be seen that there is a need for an interactive television system providing interactive television software that can be seamlessly used across mobile devices and televisions while preserving software state.

Currently there are no known prior art methods that offer a solution to this problem.

Following paragraphs in current section describe relevant prior arts in this field.

Prior art US Doc 20070130592 proposes a set top box that provides a receiving bay to enable a cellular phone to be connected to a set top box. This connectivity only enables content download from set top box into a cellular phone which may have internet connectivity. This does not address the problem of preserving application software state across a mobile device and a television.

Prior art U.S. Pat. No. 7,027,768 proposes a docking station embedded in a set top box to connect a mobile phone for providing internet connectivity to a set top box. But this does not address the problem of preserving application software state across a mobile device and a television.

Prior art US Doc 20080151862 proposes multiply routing media stream inside a media appliance to multiple media processors. But this does not address the problem of preserving application software state across a mobile device and a television.

Prior art US Doc 20050262542 proposes a television chat system to be used with television for enabling multiple users to interact in real time while viewing a television. But this does not address the problem of preserving application software state across a mobile device and a television.

The company Tivo offers a set top box that enables recording, pausing and replay of broadcast video. They also offer recordings to be transferred to mobile devices after appropriate format conversions. In addition they offer ability to record television shows from a mobile phone or other internet connected devices. But this does not address the problem of preserving application software state across a mobile device and a television.

Similarly the company Samsung introduced a portable media player that can receive an input video signal so that television shows can be recorded directly into a portable device. But this only enables recording of shows and does not enable use of other application software to interact with the content. This also does not address the problem of preserving application software state across a mobile device and a television.

As can be seen from above, all known prior arts suffer from some limitations in offering a solution to address the need for an interactive television system that preserves application software state across a mobile device and a television.

### OBJECTS AND ADVANTAGES

Accordingly, several objects and advantages of the present invention are:
a) to provide an interactive television system where software state of applications that are used for interactive television is preserved across usage with television and away from television at a mobile device.
b) to provide an interactive television system that enables efficient transfer of data from a video signal into applications at the mobile device; and
c) to provide an interactive television system that enables use of mobile device software to interact with television content.

### SUMMARY

In accordance with present invention an interactive television system is described that enables use of software applications supporting interactive television across a television and a mobile device, without losing software state or application context when a user moves from fixed usage pattern to a mobile usage pattern or vice versa.

Application software state can be retained across multiple devices by either using synchronization methods or use of a single set of applications across multiple devices.

Synchronization methods can be used for persistent data by specifying common data interchange formats, but synchronizing application runtime state is impossible without complex inter working between different applications.

Hence our invention proposes using a single set of applications running at a mobile device to also interact with television signals thus providing an interactive television system where a user can continue to use the application software while in proximity to a television or otherwise, as use of a single set of applications implies use of a single state and hence avoiding the need to synchronize multiple states.

This is achieved by implementing a mobile device that can intercept broadcast television signals and combine the intercepted television signal with output of software applications running at the mobile device to produce a combined signal that can then be viewed in a television. Such a mobile device enables interactivity with television signals using software applications running at the mobile device, hence avoiding the need for data transfer across applications that may be running at a set top box.

Such a mobile device is implemented to intercept television signals using a wired or wireless means of communication between the mobile device and a device that is an origin of television signals such as a set top box, direct cable input or other means. In wired means of communication, television signals are input into a mobile device using a physical jack for input cable connectivity and then these signals are routed to a television tuner chip inside the mobile device which are then converted to a format suitable for combining with data output of software applications running at the mobile device. Then these television signals in appropriate formats are combined with output of software applications to generate combined digital video content. This combined digital video content is then converted to a video signals appropriate for display onto a television. Then video signals appropriate for display onto a television are sent to a television using a cable.

In wireless means of communication, television signals are input into a mobile device using wireless signals from either a set top box or directly from the air, and then converted to a format appropriate for combining with data output of output of software applications. Then these television signals in appropriate formats are combined with output of software applications to generate combined digital video content. This combined digital video content is then converted to a video signals appropriate for display onto a television. Then video signals appropriate for display onto a television are sent to a television using a wired or wireless communication medium.

Additionally, a new kind of set top box is also proposed such that the set top box is capable of interacting with a mobile device to receive output of software applications from a mobile device and combining with video content being displayed. This enables a set top box to use applications on the mobile device for providing interactive television rather than using software in the set top box. DRAWINGS—FIGURES

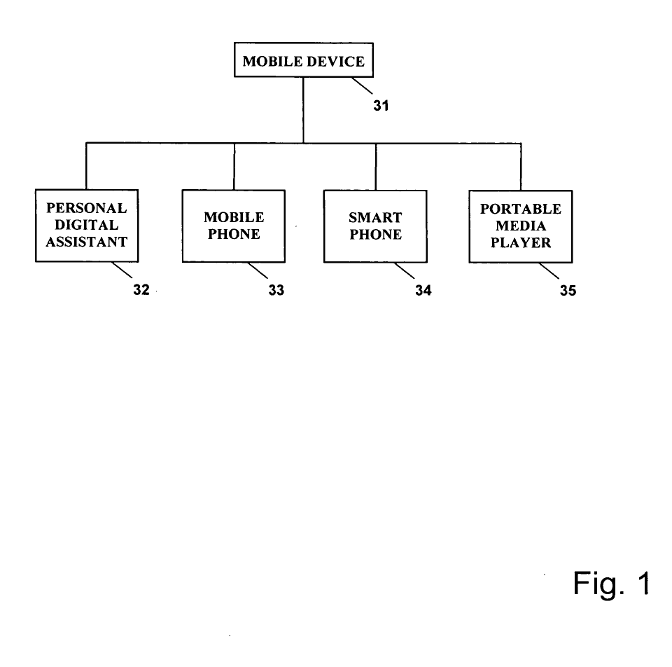

FIG. 1 shows a mobile device that can be one of personal digital assistant, mobile phone, smartphone and portable media player.

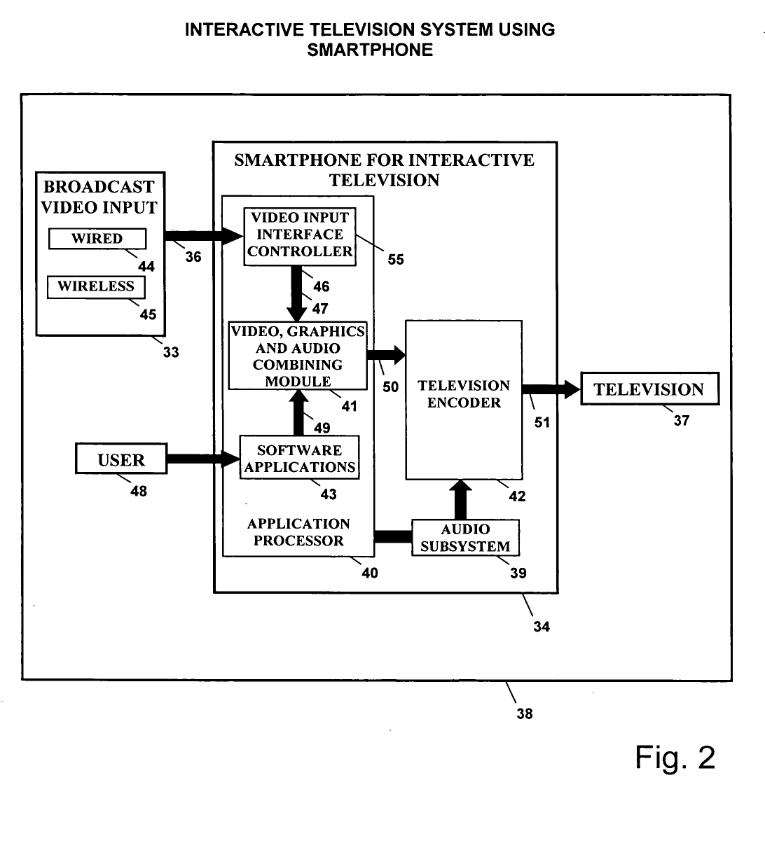

FIG. 2 shows an interactive television system using a smartphone.

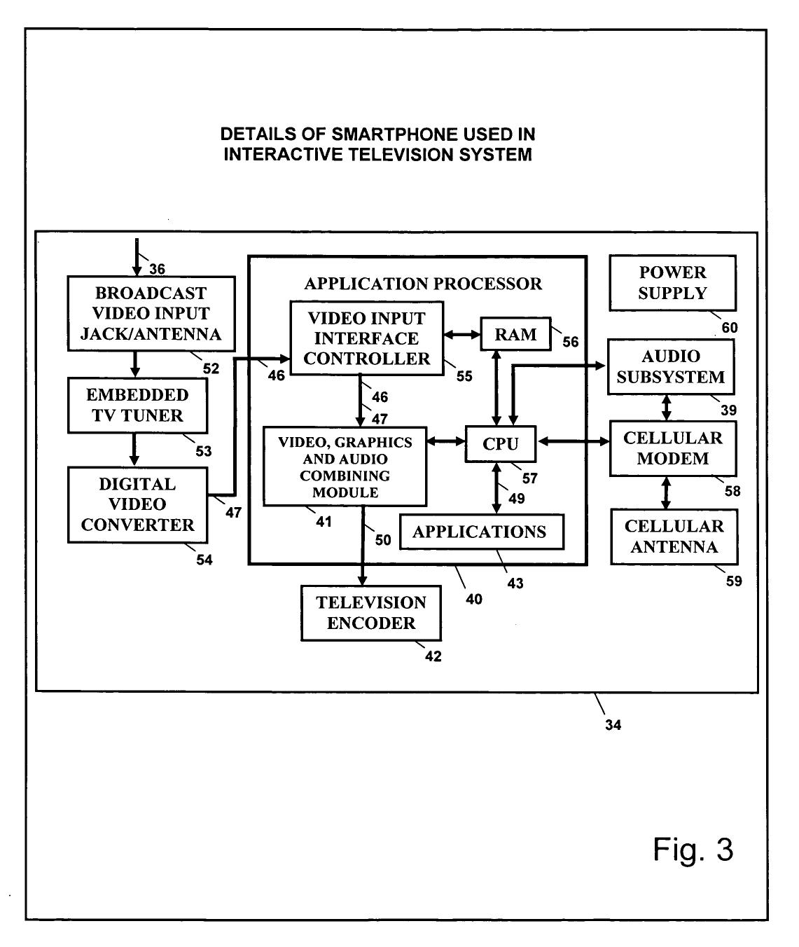

FIG. 3 shows further details of a smartphone used in the interactive television system.

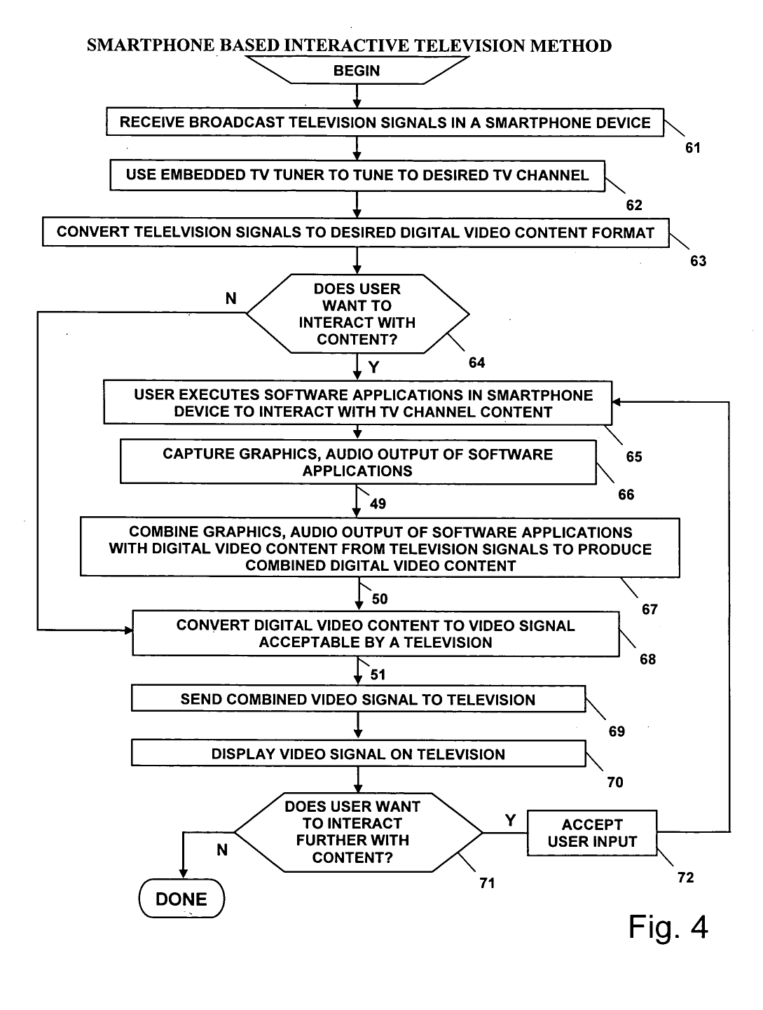

FIG. 4 shows a flow chart of how a broadcast television signal is intercepted and combined with output of software applications running at the mobile device and then the combined signal is viewed at a television (TV).

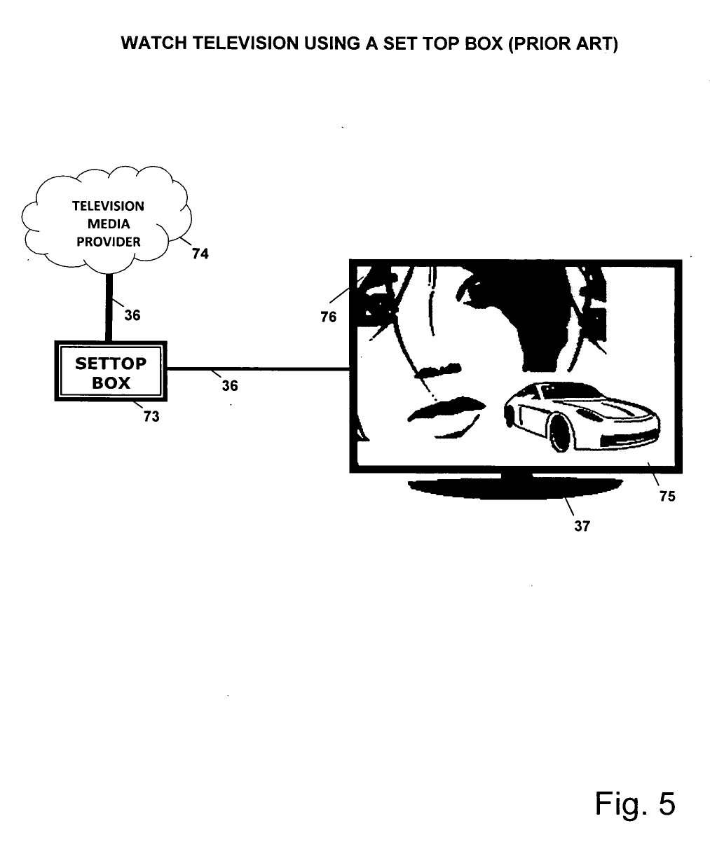

FIG. 5 shows a prior art setup in which a user watches television using a set top box.

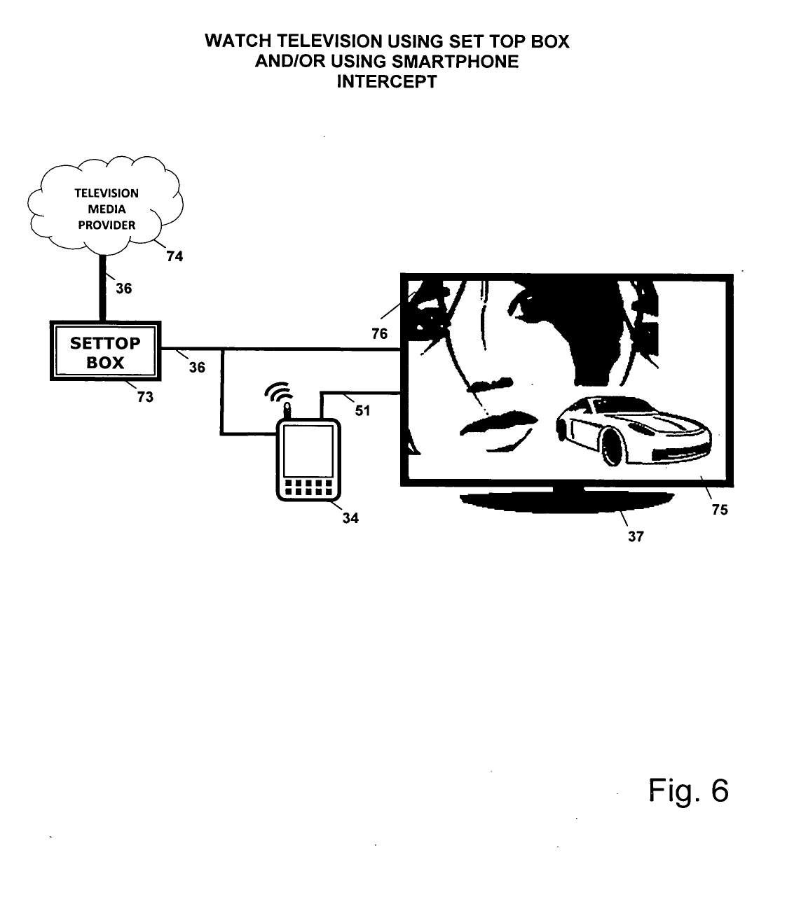

FIG. 6 shows a use case of present invention where a user can watch television using a set top box or can watch television using a smartphone by intercepting television signals and combining with output of software applications, or can do both.

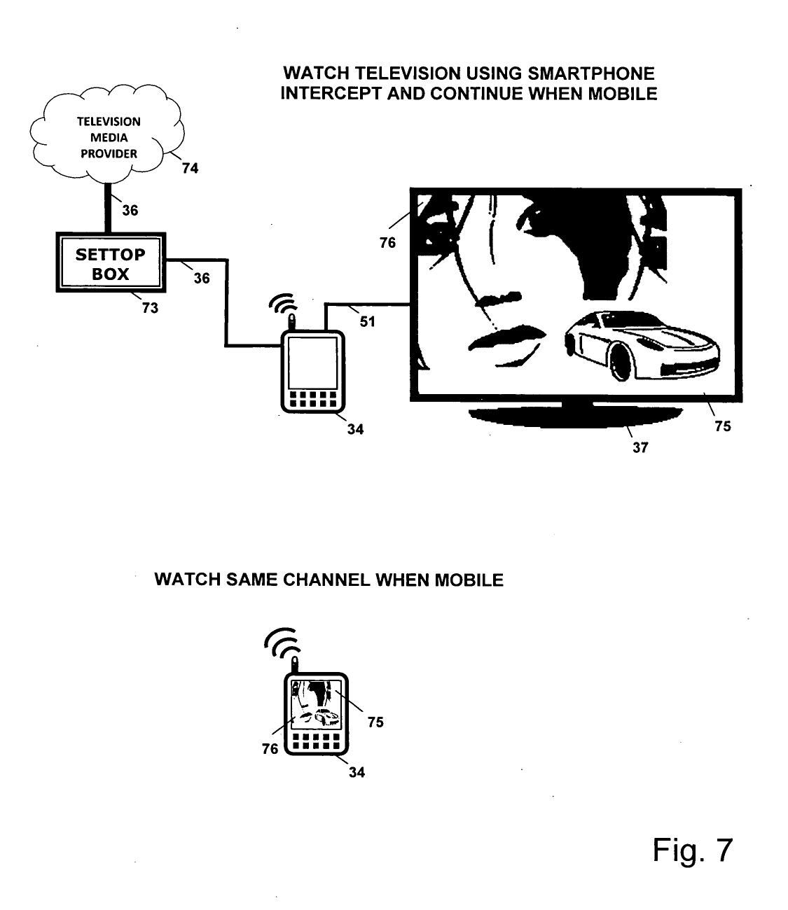

FIG. 7 shows that a user may choose to watch television using a smartphone that can provide interactivity with television signals, using software applications running at the smartphone, and continue to watch the same channel when mobile using over the air broadcasts along with interaction without losing any software state.

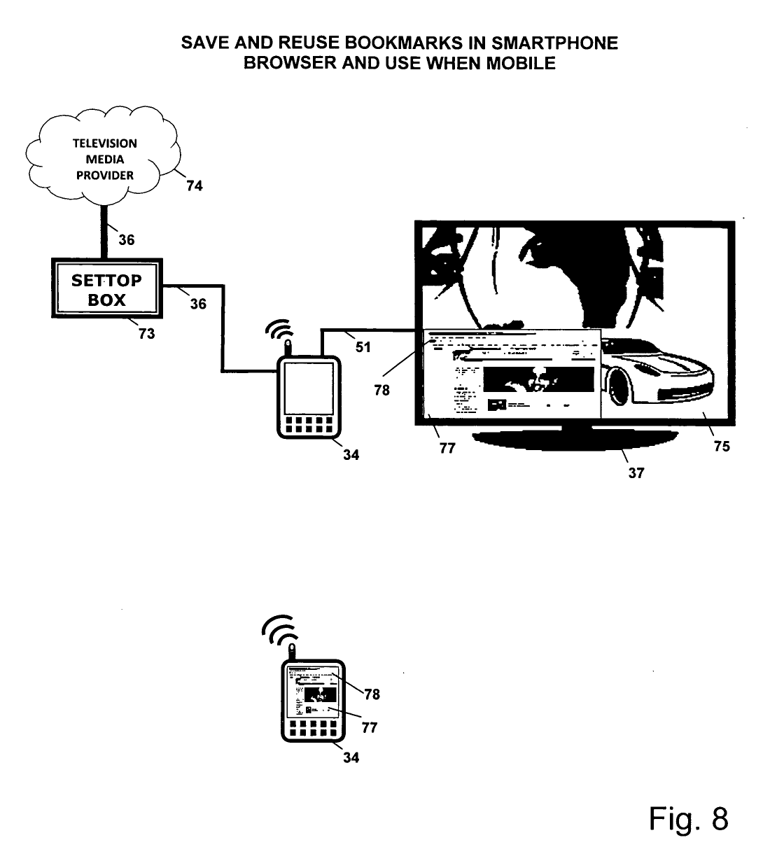

FIG. 8 shows a use case of present invention where a user saves browser bookmarks when watching television and reuses the bookmarks when mobile.

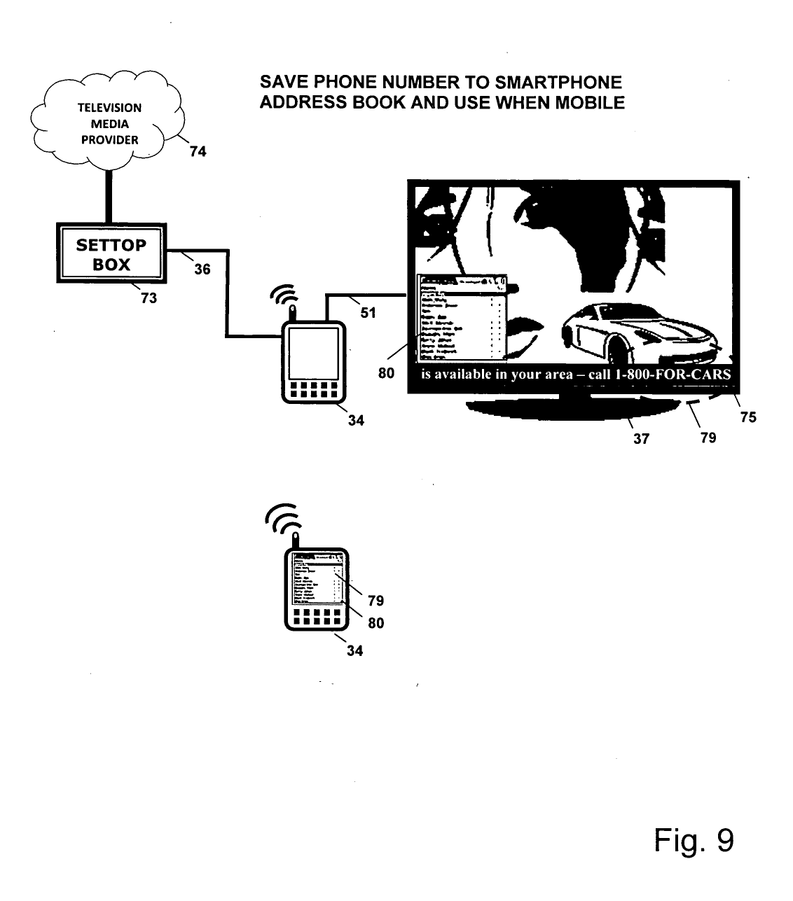

FIG. 9 shows a use case of present invention where a user saves phone number in address book of the smartphone when watching television and uses the phone number when mobile.

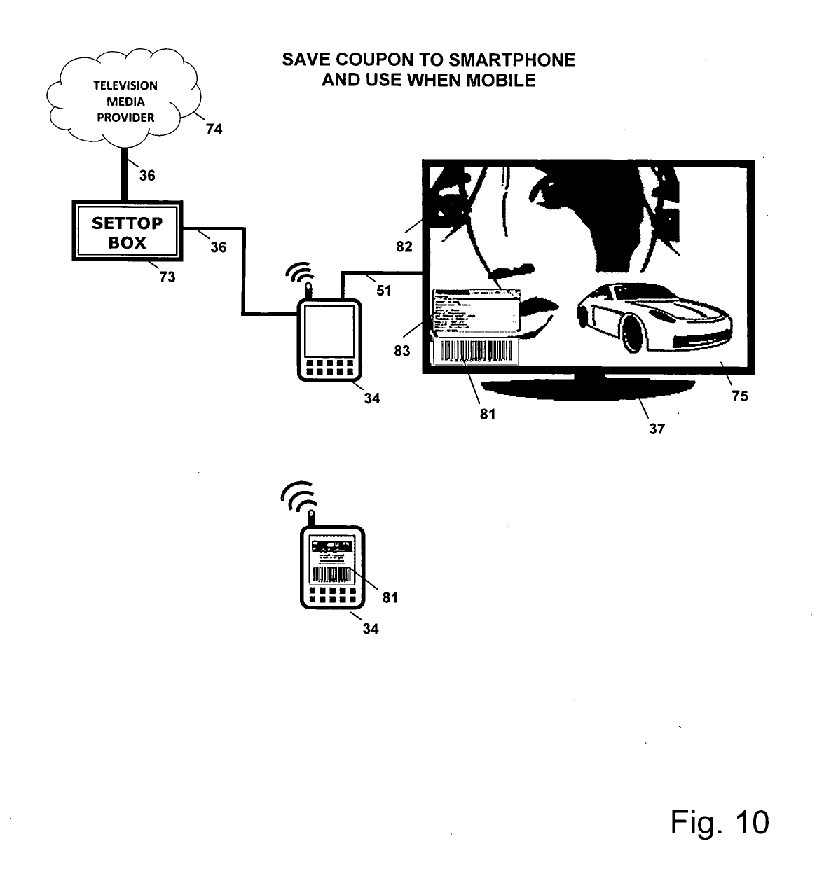

FIG. 10 shows a use case of present invention where a user saves a coupon when watching television and uses the coupon when mobile.

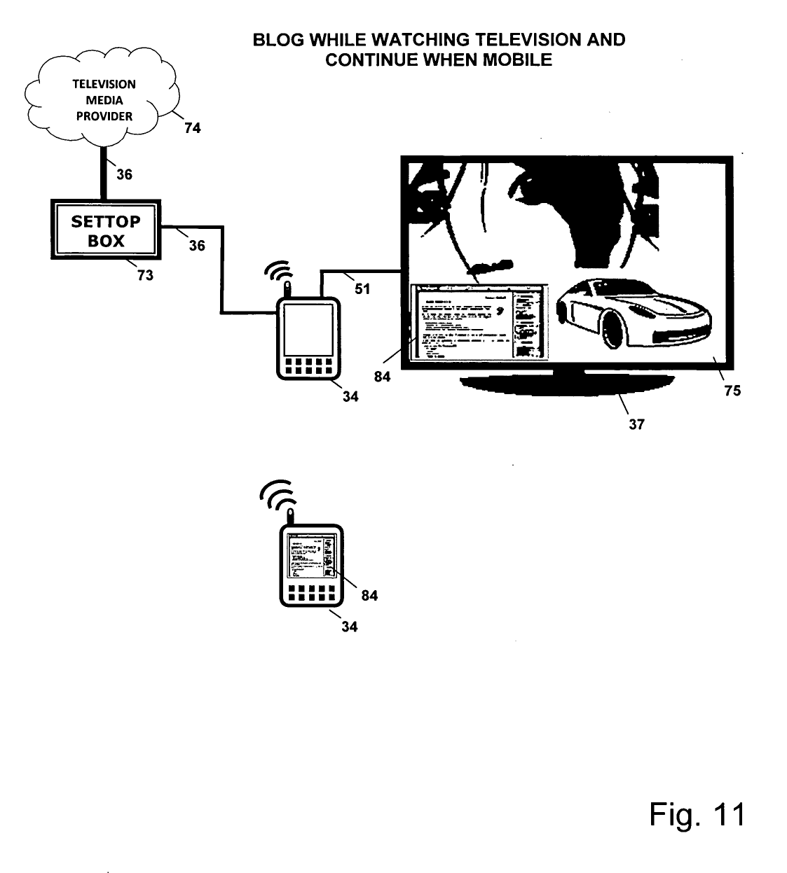

FIG. 11 shows a use case of present invention where a user edits content in a public website (blog) when watching television and continues the blogging session when mobile.

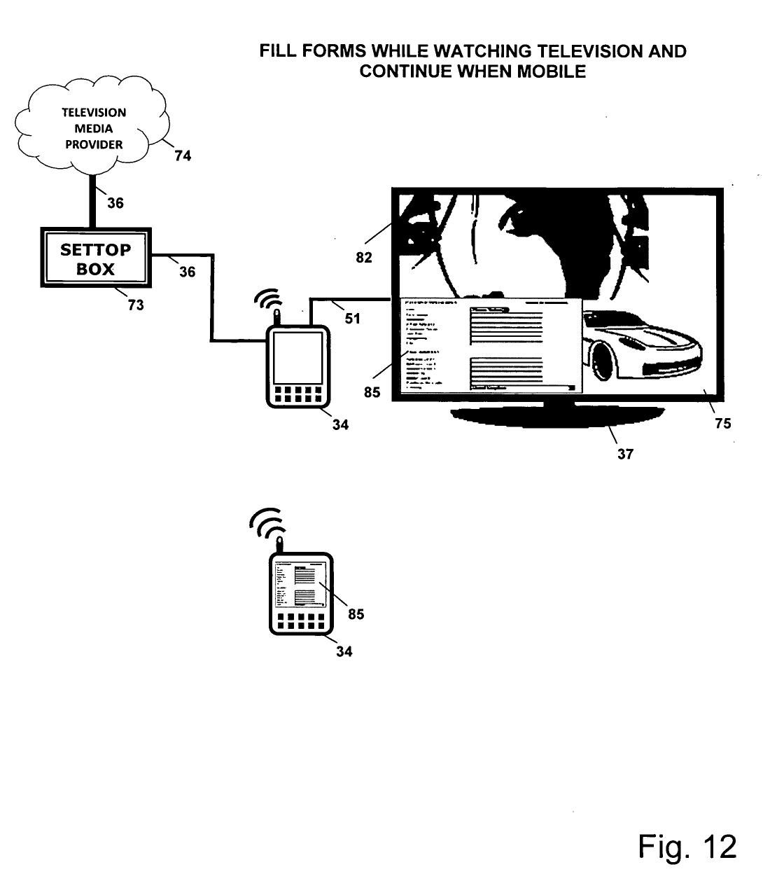

FIG. 12 shows a use case of present invention where a user fills forms online when watching television and continues the form filling session when mobile.

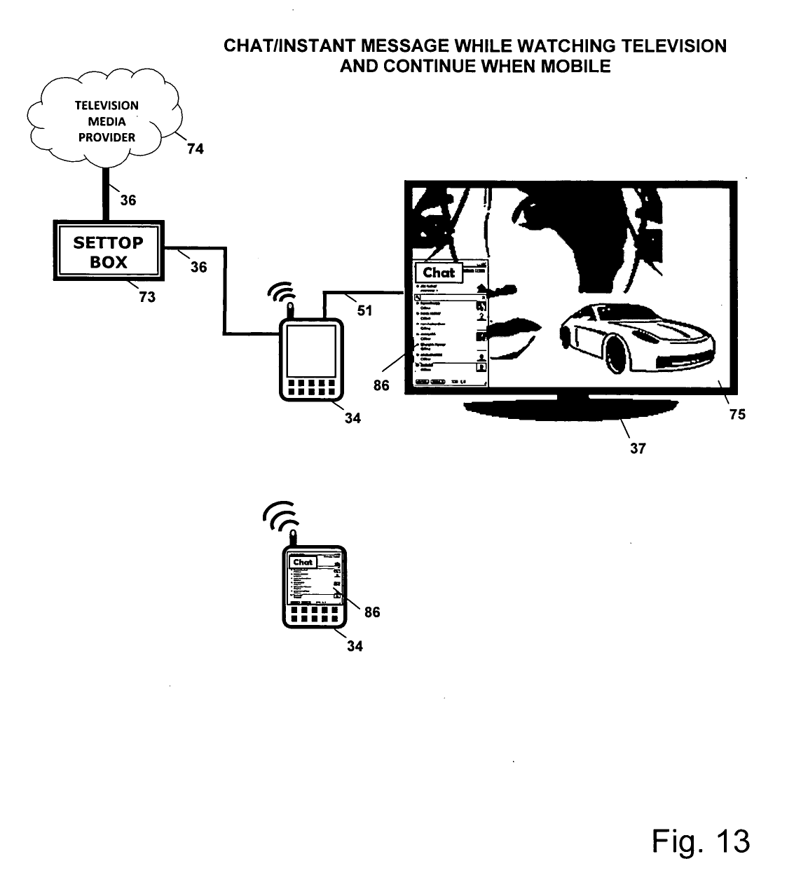

FIG. 13 shows a use case of present invention where a user is engaged in a chat or instant message session when watching television and continues the chat or instant message session when mobile.

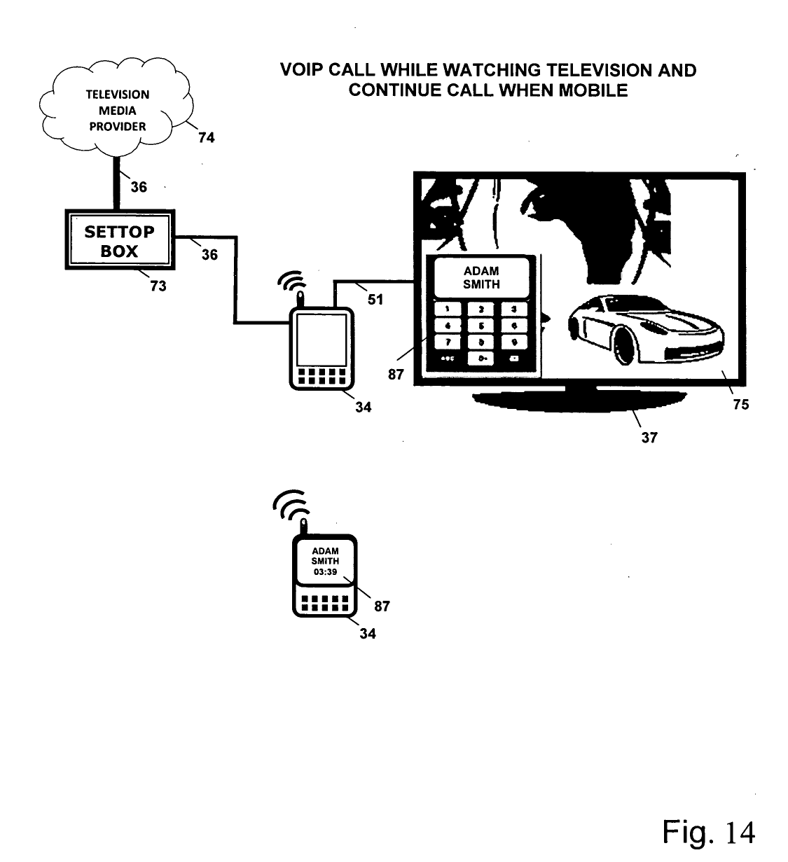

FIG. 14 shows a use case of present invention where a user is engaged in a voice over internet protocol call (VOIP) when watching television and continues the call when mobile.

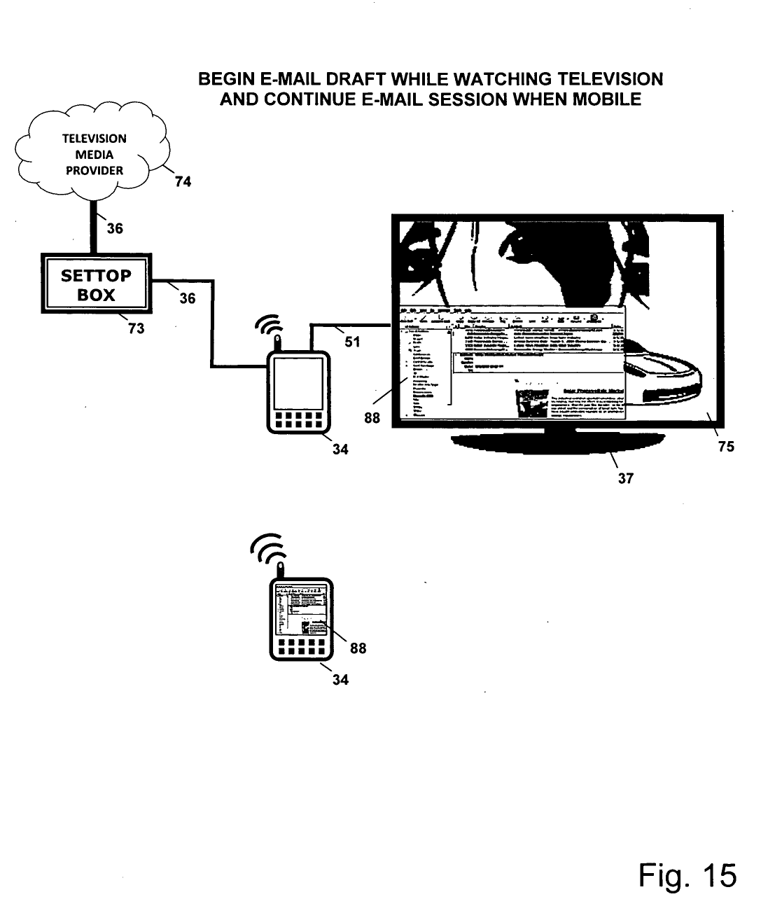

FIG. 15 shows a use case of present invention where a user starts an electronic mail session when watching television and continues the electronic mail session when mobile.

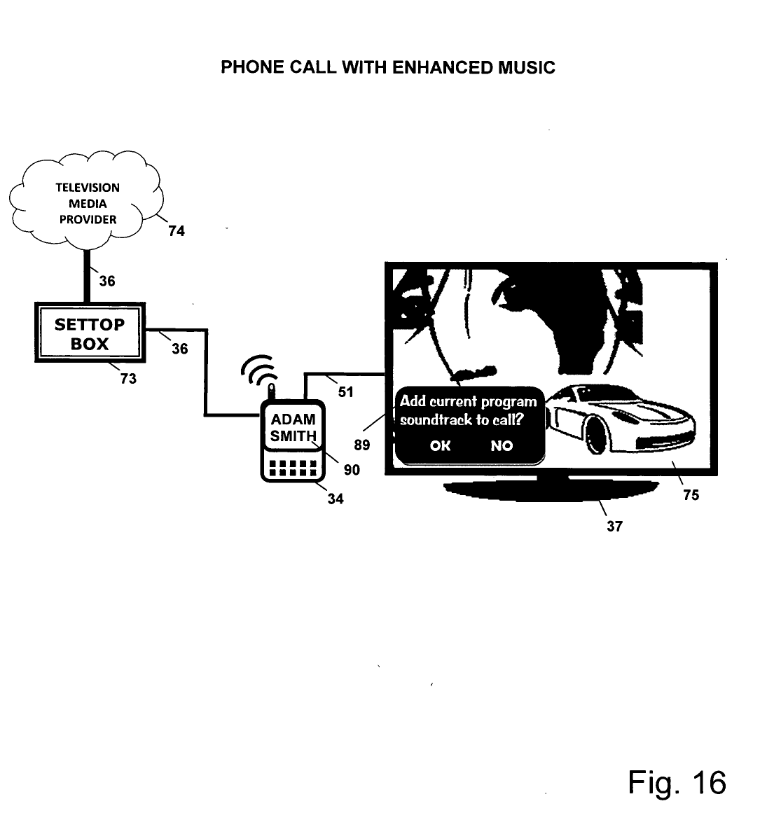

FIG. 16 shows a use case of present invention where a user can route background music from television signal into an ongoing phone call.

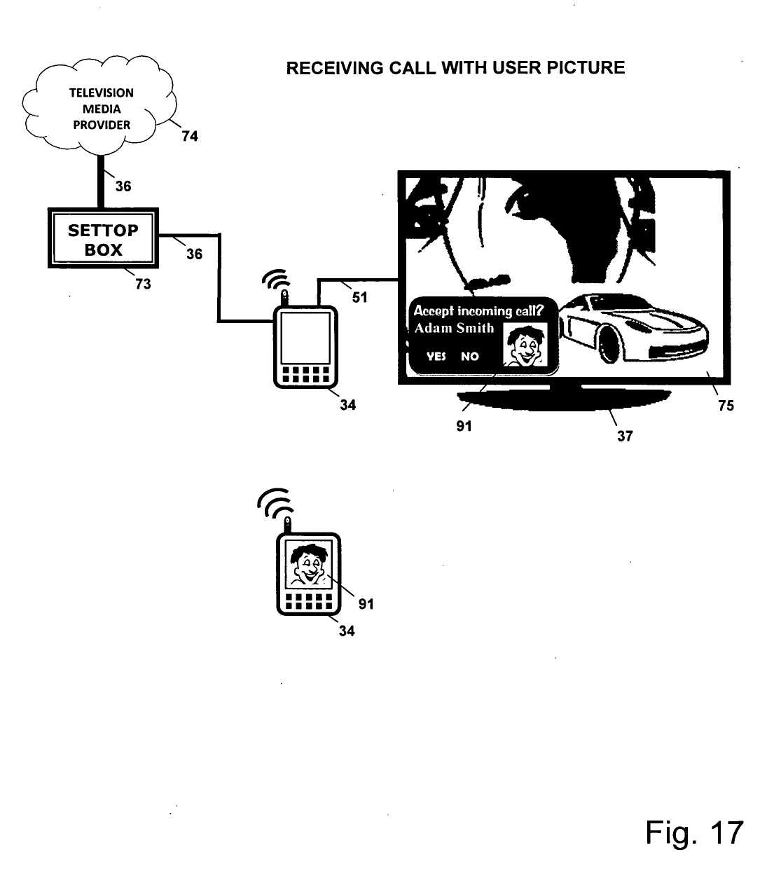

FIG. 17 shows a use case of present invention where a user sees a picture of incoming caller when watching television and continues the call when mobile.

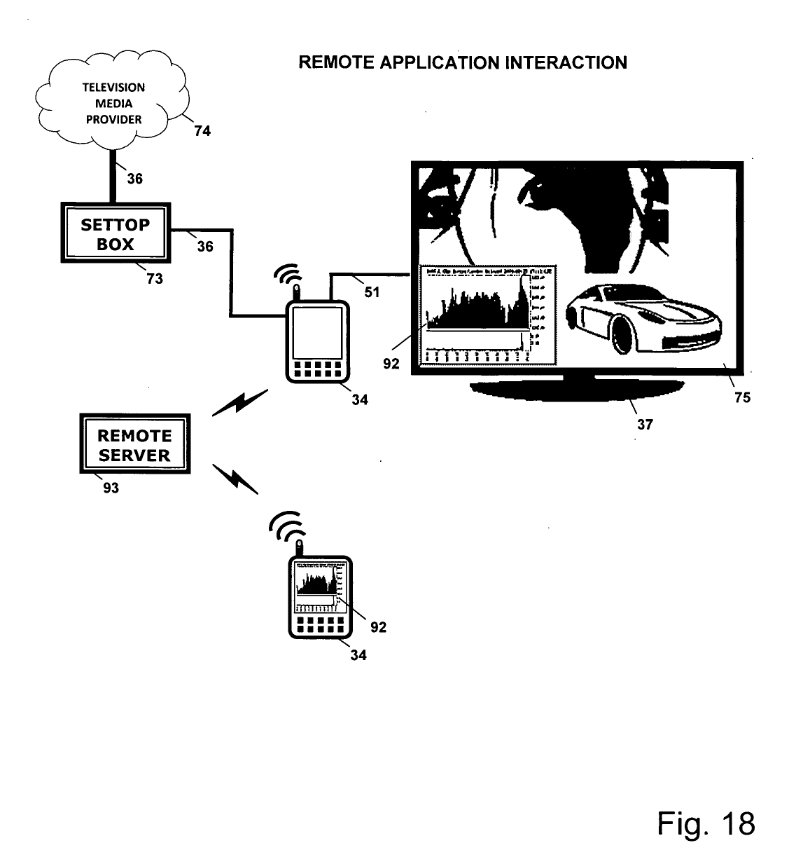

FIG. 18 shows a use case of present invention where a user interacts with remote applications when watching television and continues to interact with the remote applications when mobile.

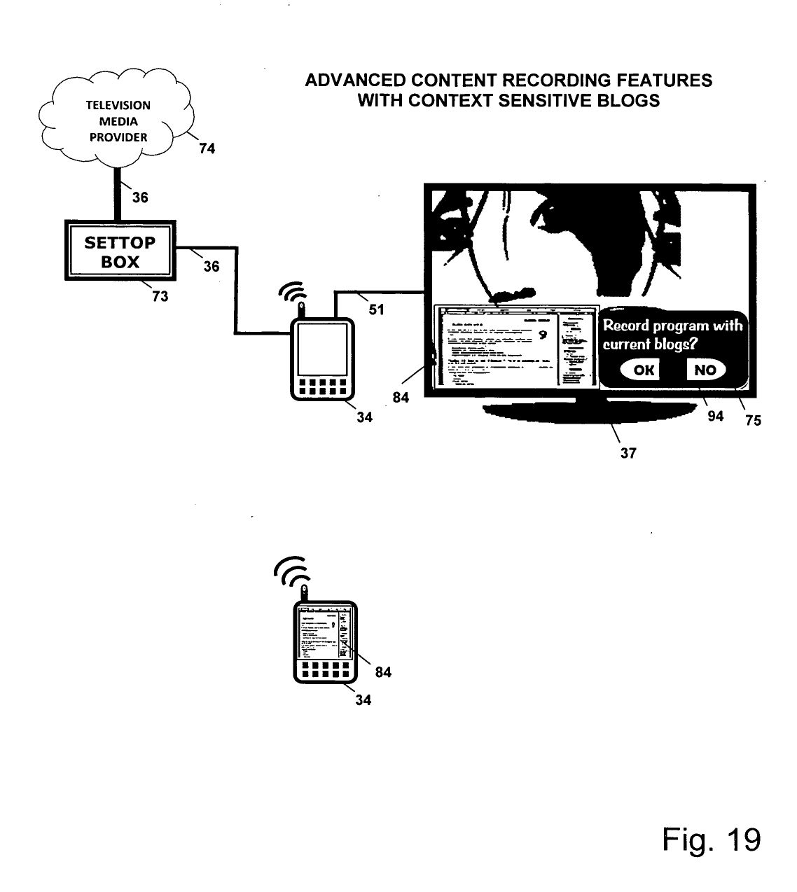

FIG. 19 shows a use case of present invention where a user records television programs along with real time blogs when watching television and continues to interact with the blogs when mobile.

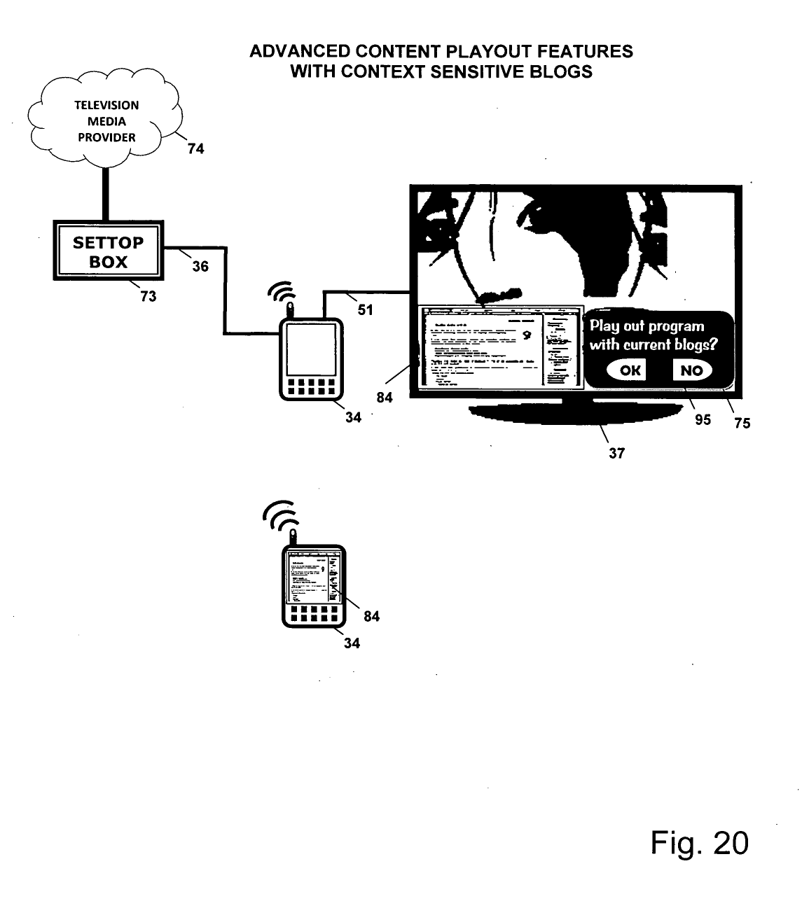

FIG. 20 shows a use case of present invention where a user plays out recorded television programs along with context sensitive blogs using applications running at the smartphone.

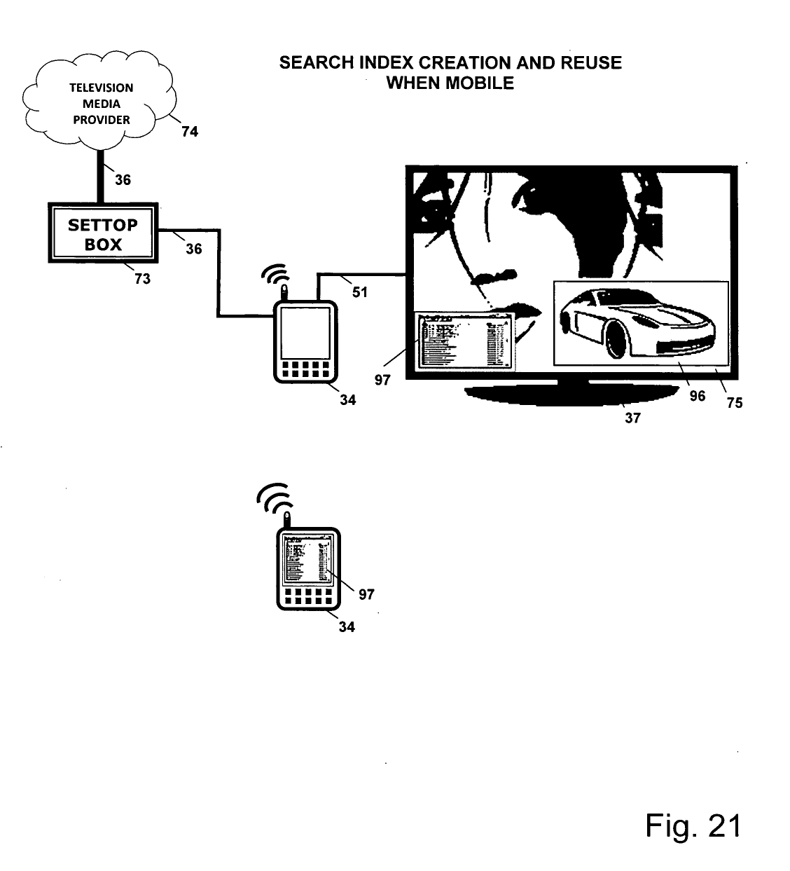

FIG. 21 shows a use case of present invention where a user creates search indexes related to content being viewed while watching television and continues to interact with the search indexes when mobile.

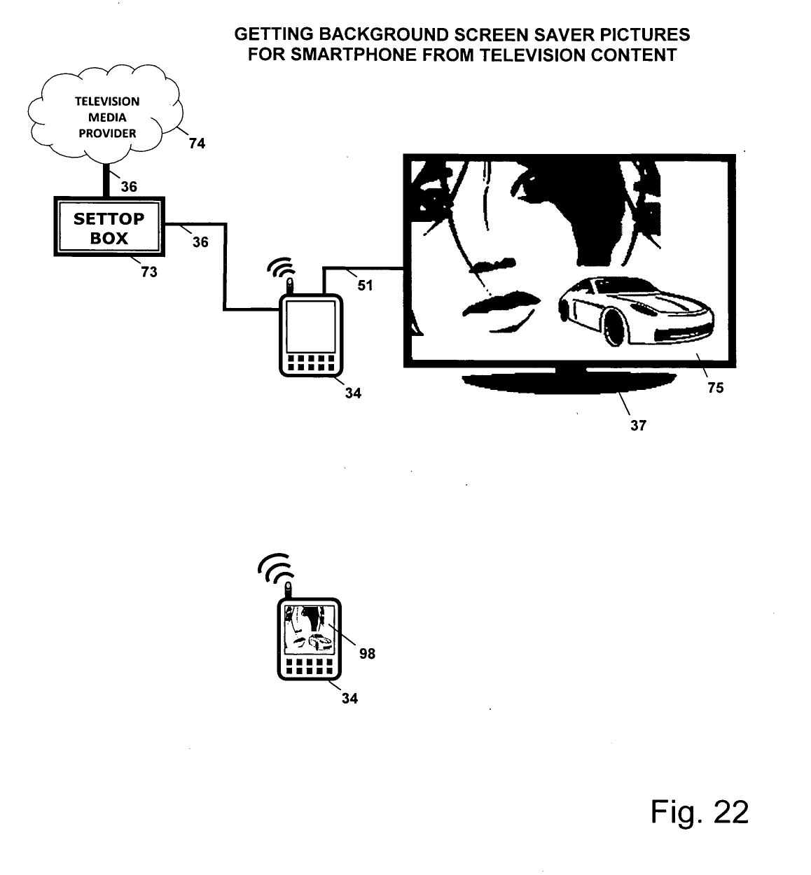

FIG. 22 shows a use case of present invention where a user creates screen savers for smartphone using television content and uses the screen savers when mobile.

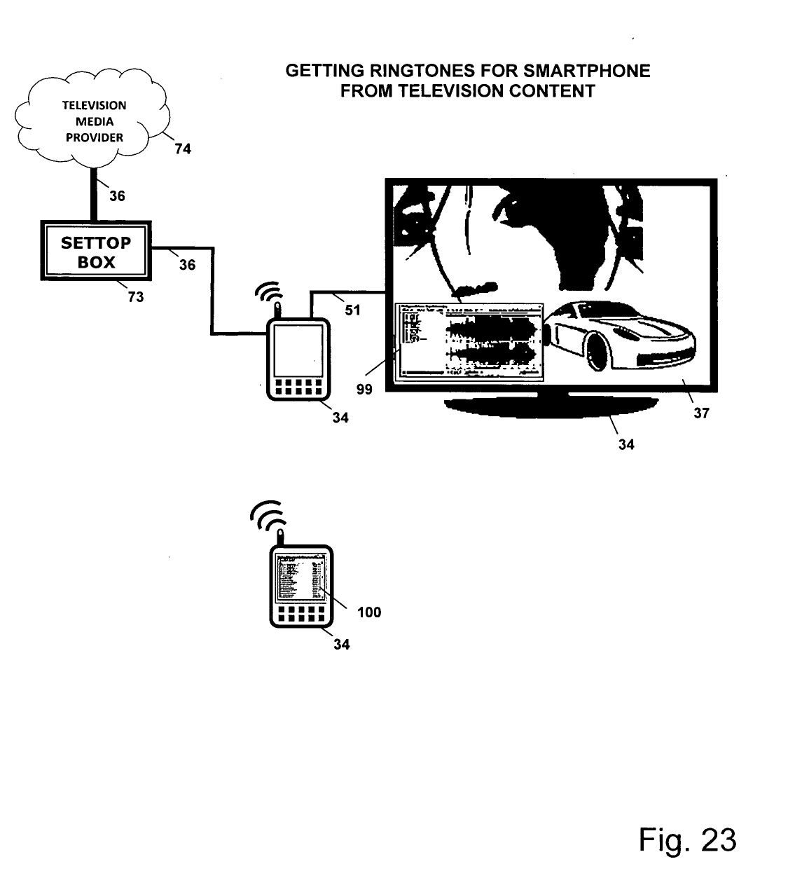

FIG. 23 shows a use case of present invention where a user creates ringtones from sound tracks when watching television and uses the ringtones when mobile.

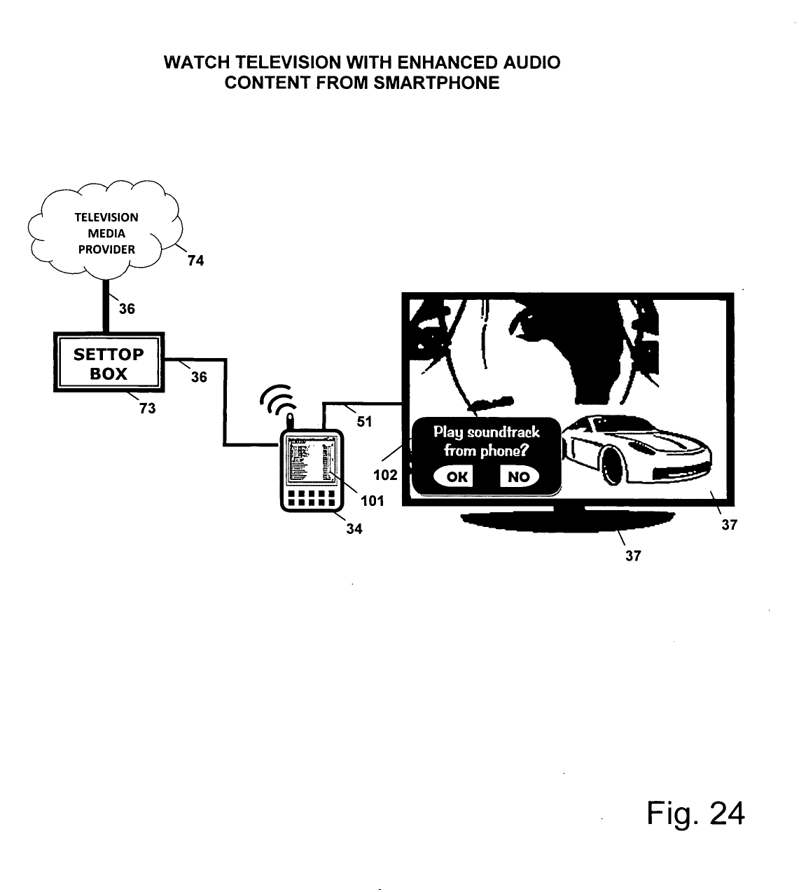

FIG. 24 shows a use case of present invention where a user is able to combine audio content from smartphone into video content being viewed by a user to enhance the audio experience.

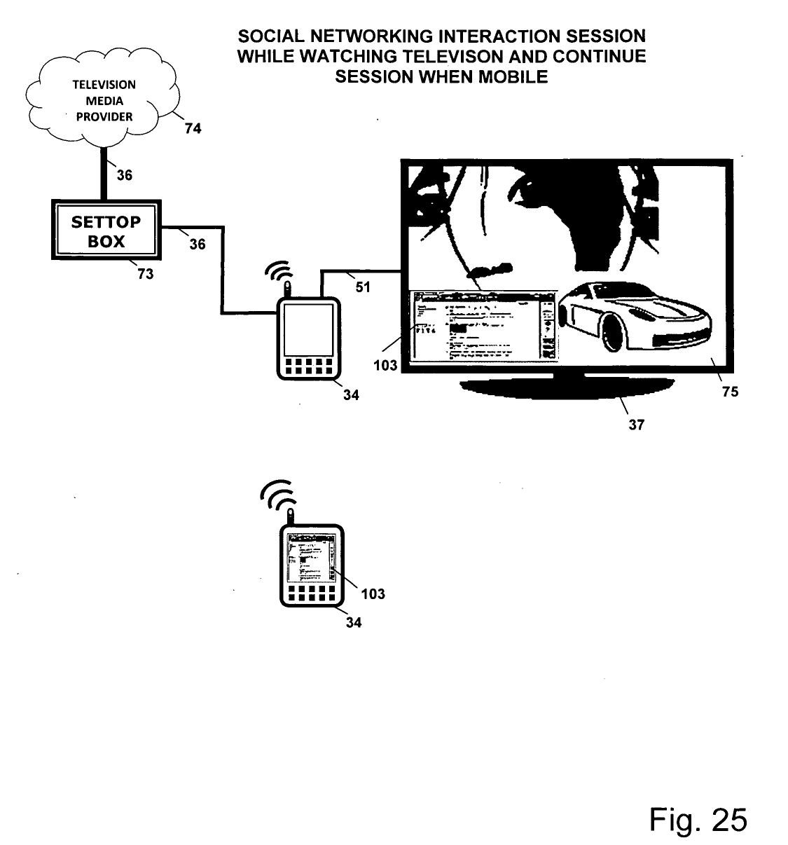

FIG. 25 shows a use case of present invention where a user is engaged in a social networking interaction session when watching television and continues the social networking interaction session when mobile.

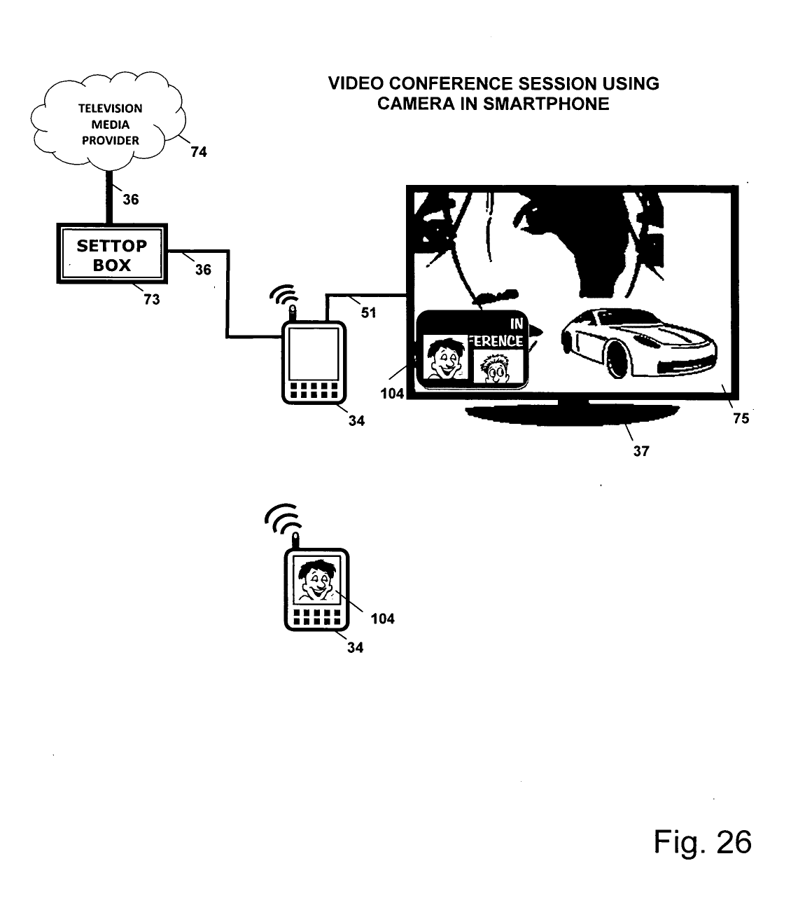

FIG. 26 shows a use case of present invention where a user is engaged in a video conferencing session using camera embedded in smartphone when watching television and continues the video conferencing session when mobile.

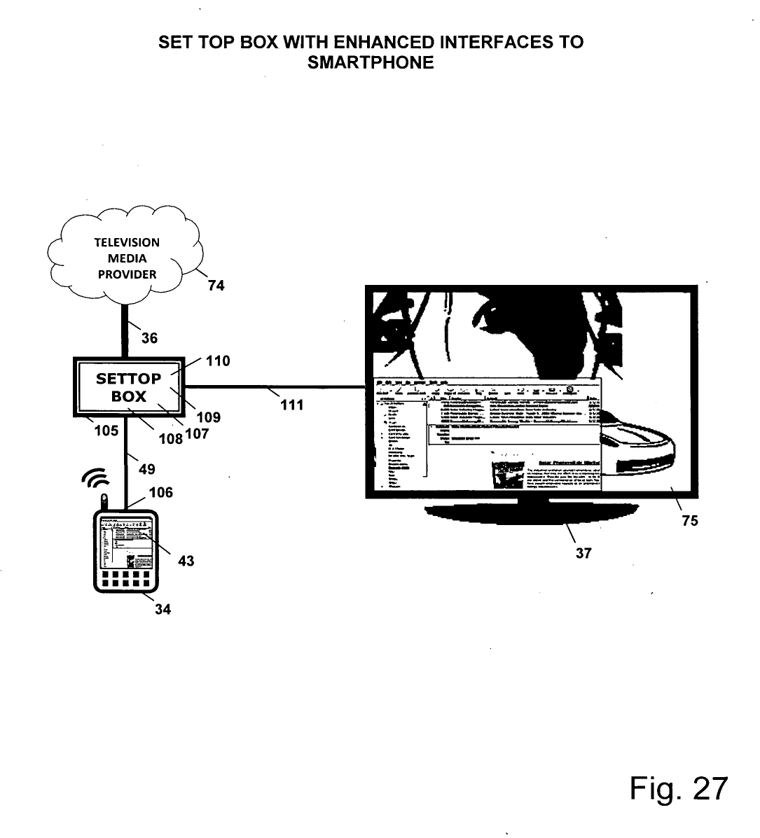

FIG. 27 shows a set top box with enhanced hardware and software interfaces that can combine output of software applications from a mobile device with television content. This is an alternative arrangement where smartphone software is used only to interact with television content at the set top box instead of smartphone providing both application software and interception of television content.

### DRAWINGS—REFERENCE NUMERALS

31 mobile device

32 personal digital assistant

33 mobile phone

34 smartphone

35 portable media player

36 broadcast television signals

37 television

38 interactive television system using a smartphone

39 audio subsystem

40 applications processor

41 video, graphics and audio combining module

42 television encoder

43 software applications

44 wired interface

45 wireless interface

46 digital video content

47 digital video content format

48 user

49 graphics, audio output of software applications

50 combined digital video content

51 television acceptable encoded signal

52 broadcast video input jack or antenna

53 embedded television tuner

54 digital video converter

55 video input interface controller

56 random memory access unit

57 central processing unit

58 cellular modem

59 cellular antenna

60 power supply

61 step

62 step

63 step

64 step

65 step

66 step

67 step

68 step

69 step

70 step

71 step

72 step

73 set top box

74 television media provider

75 video images

76 television channel

77 internet browser application

78 browser bookmarks

79 phone number

80 address book

81 coupon

82 television advertisement

83 coupon list

84 blogs

85 shopping cart

86 instant messaging chat conversation

87 voice over internet protocol session call

88 electronic mail

89 background music

90 call with enhanced music

91 image of a caller

92 remote application

93 remote server

94 blog recording menu

95 blog association menu

96 regions in television content

97 searchable indexes

98 screensaver or background image

99 soundtracks

100 ringtones

101 audio content in smartphone

102 audio content selection menu

103 social networking sites

104 video conferencing session

105 set top box with enhanced interface

106 alternate communication interface with mobile device

107 digital video content in set top box

108 digital video content format in set top box

109 combined digital video content in set top box

110 television encoder in set top box

111 television compatible encoded signal in set top box

### DETAILED DESCRIPTION OF PREFERRED EMBODIMENT

In the following description, first a mobile device of present invention is described that is used to intercept broadcast television signals to provide interactivity. Then the method used to intercept television broadcast television signals is described in further detail. In addition several use cases are described that show different scenarios under which software applications in the mobile device of present invention are used to interact with contents of broadcast television signals, to provide a user with seamless application use whether a user is mobile or is connected to a television using wired or wireless interfaces.

FIG. 1 shows a mobile device 31 that can be one of personal digital assistant 32, mobile phone 33, smartphone 34 and portable media player 35. Mobile device 31 is capable of receiving broadcast television signals 36 and sending output to a television 37. Broadcast television signals 36 can be either analog broadcast television signals or digital broadcast television signals.

FIG. 2 shows a block diagram of a interactive television system using a smartphone 38. Interactive television system 38 consists of smartphone 34 that is made up of a audio subsystem 39, an applications processor 40, a video, graphics and audio combining module 41, a television encoder 42 and a set of software applications 43. Smartphone 34 receives as input broadcast television signals 36 using a wired interface 44 or a wireless interface 45. Wired interface 44 consists of an input jack to receive video signals from wired broadcast video sources that include cable television, cable television set top box output and satellite television set top box output. Wireless interface 45 can receive analog video broadcast and digital video broadcast directly from the air.

Broadcast television signals 36 are converted to digital video content 46 in a digital video content format 47 and then routed to video, graphics and audio combining module 41. Then a user 48 interacts with the software applications 43 on smartphone 34 to produce graphics, audio output of software applications 49. This output of software applications 49 is also sent to the video, graphics and audio combining module 41. Now digital video content 46 in digital video content format 47 is then combined with output of software applications 49 by video, graphics and audio combining module 41 to produce a combined digital video content 50. Combined digital video content 50 is then sent to the television encoder 42 to produce television acceptable encoded signal 51. After encoding, television acceptable encoded signal 51 is then sent to television 37.

Note that the term graphics used above could mean any graphical output of software applications 43 in smartphone 34 that could include text, images, decoded digital video frames and other graphical drawing primitives.

FIG. 3 shows further details of smartphone 34 used to intercept broadcast television signals in interactive television system 38. It is made up of several components including a broadcast video input jack or antenna 52, a embedded television tuner 53 and a digital video converter 54.

Broadcast television signal 36 is received at broadcast video input jack 52, then routed to embedded television tuner 53 that enables tuning to a particular television channel and then contents of tuned television channel are routed to digital video converter 54 to produce digital video content 46 in desired digital video content format 47.

Smartphone 34 also has application processor 40 that consists of a video input interface controller 55, video, graphics and audio combining module 41, a random memory access unit 56, a central processing unit 57 and software applications 43. Application processor 40 is also connected to audio subsystem 39, television encoder 42 and a cellular modem 58. Cellular modem 58 is connected to a cellular antenna 59 that is used to transmit and receive wireless signals. Smartphone 34 is powered by an internal power supply 60.

Application processor 40 is used to execute software applications 43 that interact with digital video content of a desired television channel to produce output of software applications 49. This output of software applications 49 is then combined with digital video content in desired digital video content format 47 by video, graphics and audio combining module 41 to produce combined digital video content 50.

FIG. 4 shows a flow chart of the method that describes how a user can interact with interactive television system 38 using smartphone 34.

In step 61 broadcast television signals 36 are intercepted and received in smartphone 34. Then in step 62 embedded television tuner 53 is used to tune to a desired television channel. In step 63 contents of tuned television channel are converted to digital video content 46 representing input television signal in desired digital video content format 47.

In step 64 a check is made to see if user 48 wants to interact with content of tuned television channel.

In step 65 if user 48 wants to interact with content of tuned television channel then user 48 executes software applications to enable desired interaction.

In step 66 graphics, audio output of software applications 49 is captured.

Then in step 67 captured graphics, audio output of software applications 49 is combined with digital video content 46 to generate a combined digital video content 50.

In step 68 combined digital video content 50 is converted to a video signal that is accepted by television 51.

In step 69 converted video signal 51 is sent to television 37.

In step 70 converted video signal 51 is displayed on television 37.

In step 71 if user 48 further wants to interact with tuned television content, user input is accepted in step 72 and this method is repeated from step 65.

FIG. 5 shows a prior art scenario in which user 48 watches television 37 connected to a set top box 73. A television media provider 74 sends broadcast television signals 36 to set top box 73. Set top box 73 allows user 48 to select a desired channel to watch and then routes desired television channel to television 37 where user 48 sees video images 75.

FIG. 6 shows a use case of present invention in which user 48 has an option to watch television channel 76 on television 37 using set top box 73 or using smartphone 34. In case user 48 chooses to watch television 37 using smartphone 34, then broadcast television signals 36 are intercepted by smartphone 34, converted to television acceptable encoded signal 51 and then routed to television 37.

FIG. 7 shows a use case of present invention where user 48 begins watching a desired television channel 76 in television 37 through smartphone 34 then continues to watch the desired television channel 76 even when mobile. This is possible only if software applications 43 running on smartphone 34 maintain information about channel being viewed by a user as part of software sate.

Software applications 43 running on smartphone 34 detect television channel 76 currently being viewed by user 48 and saves this state information as software state in smartphone 34. When user 48 disconnects link between smartphone 34 and television 37 and becomes mobile, the saved state is recovered to tune to broadcast television signals 36 broadcast over the air using television receiver on smartphone 34 to watch the same television channel 76. This enables seamless transition of the application use between television 37 and smartphone 34 when mobile. Digital television has more than hundred channels over the air so a number of common channels are available to leverage this feature.

FIG. 8 shows a use case of present invention where user 48 watches television 37 through a smartphone 34 and interacts with a internet browser application 77 and continues this interaction even when mobile. While watching television 37 user 48 browses the internet using internet browser application 77 and saves a few browser bookmarks 78 relevant to television channel 76 being viewed. When user 48 moves away from television 37, browser bookmarks 78 can be recalled and reused on smartphone 34. This again shows how a single set of applications is used while watching television or being mobile, as compared to using applications on a set top box and later synchronizing with mobile devices.

FIG. 9 shows a use case of present invention where user 48 watches television 37 through a smartphone 34. While watching television 37 user 48 clicks on video images 75 that show a phone number 79. Part of the video image 75 is copied as is or saved as data by running optical character recognition application software on smartphone 34. The phone number 79 can then be added to address book 80 on smartphone 34. When user 48 moves away from television 37, phone number 79 in address book 80 can be recalled and dialed on smartphone 34 to engage in a conversation. This again shows how a single set of applications is used while watching television or being mobile, as compared to using applications on a set top box and later synchronizing with mobile devices.

FIG. 10 shows a use case of present invention where user 48 watches television 37 through a smartphone 34. While watching television 37 user 48 clicks on video images 75 that shows a coupon 81 as part of a television advertisement 82. Coupon 81 is copied into smartphone 34 and added to a coupon list 83. When user 48 moves away from television 37, coupon 81 from coupon list 83 can be recalled on smartphone 34 and used is stores while shopping. This again shows how a single set of applications is used while watching television or being mobile, as compared to using applications on a set top box and later synchronizing with mobile devices.

FIG. 11 shows a use case of present invention where user 48 watches television 37 through a smartphone 34. While watching television 37 user 48 fills in blogs 84 relevant to television channel 76 being viewed. When user 48 moves away from television 37, user 48 can continue to fill in blogs 84 on smartphone 34 without disconnecting blogs 84 session. This again shows how a single set of applications is used while watching television or being mobile, as compared to using applications on a set top box and later synchronizing with mobile devices.

FIG. 12 shows a use case of present invention where user 48 watches television 37 through a smartphone 34. While watching television 37 user 48 partially fills in forms for a shopping cart 85 relevant to television advertisement 82 in television channel 76 being viewed. When user 48 moves away from television 37, user 48 can continue to fill in the forms for shopping cart 85 on smartphone 34 without restarting shopping cart 85 session even if a server does not support persistent shopping carts. This again shows how a single set of applications is used while watching television or being mobile, as compared to using applications on a set top box and later synchronizing with mobile devices.

FIG. 13 shows a use case of present invention where user 48 watches television 37 through a smartphone 34. While watching television 37 user 48 is engaged in a instant messaging chat conversation 86 relevant to television channel 76 being viewed. The instant messaging chat conversation 86 could include background bitmaps, emoticons and sound. User 48 could take snapshots of television channel 76 being viewed and exchange them in instant messaging chat conversation 86 with other users. When user 48 moves away from television 37, user 48 can continue instant messaging chat conversation 86 on smartphone 34 without disconnecting instant messaging chat conversation 86 session. This again shows how a single set of applications is used while watching television or being mobile, as compared to using applications on a set top box and later synchronizing with mobile devices.

FIG. 14 shows a use case of present invention where user 48 watches television 37 through a smartphone 34. While watching television 37 user 48 is engaged in a voice over internet protocol session call 87 with other users and discusses content relevant to television channel 76 being viewed. When user 48 moves away from television 37, user 48 can continue call 87 on smartphone 34 without disconnecting call 87 session and having to establish call 87 again. This again shows how a single set of applications is used while watching television or being mobile, as compared to using applications on a set top box and later synchronizing with mobile devices.

FIG. 15 shows a use case of present invention where user 48 watches television 37 through a smartphone 34. While watching television 37 user 48 creates a draft electronic mail 88 about content relevant to television channel 76 being viewed. When user 48 moves away from television 37, user 48 can continue to complete the draft and send electronic mail 88 on smartphone 34 without disconnecting and having to establish an electronic mail 88 session again. This again shows how a single set of applications is used while watching television or being mobile, as compared to using applications on a set top box and later synchronizing with mobile devices.

FIG. 16 shows a use case of present invention where user 48 watches television 37 through a smartphone 34. While watching television 37 user 48 receives a call on smartphone 34. User 48 can choose to route background music 89 from television channel 76 being viewed into the call to create a call with enhanced music 90. This shows a seamless flow of data between software applications 43 in smartphone 34 and content of television 37. This again shows how a single set of applications is used while watching television or being mobile, as compared to using applications on a set top box and later synchronizing with mobile devices.

FIG. 17 shows a use case of present invention where user 48 watches television 37 through a smartphone 34. While watching television 37 user 48 receives a call on smartphone 34 that also displays a image of a caller 91 along with content relevant to television channel 76 being viewed. This enables merging image 91 stored in smartphone 34 with content from television 37. When user 48 moves away from television 37, user 48 can continue the call on smartphone 34 with the last snapshot of displayed image 91 and 37 content. This again shows how a single set of applications is used while watching television or being mobile, as compared to using applications on a set top box and later synchronizing with mobile devices.

FIG. 18 shows a use case of present invention where user 48 watches television 37 through a smartphone 34. While watching television 37 user 48 could be running a remote application 92 through smartphone 34 and is able to interact with television content being viewed. Software applications 43 could run completely on smartphone 34 or could run part on smartphone 34 and part on a remote server 93. When user 48 moves away from television 37, user 48 can continue interacting with remote application 92 through smartphone 34 without having to connect again. This again shows how a single set of applications is used while watching television or being mobile, as compared to using applications on a set top box and later synchronizing with mobile devices.

FIG. 19 shows a use case of present invention where user 48 watches television 37 through a smartphone 34. While watching television 37 user 48 fills in blogs 84 relevant to television channel 76 being viewed and also records television channel 76. The blogs 84 are interspersed in real time with recording of television channel 76 using a blog recording menu 94. User 48 can later watch television channel 76 recordings with blogs 84 pertaining to the recordings. When user 48 moves away from television 37, user 48 can continue to view television channel 76 recordings and fill in blogs 84 on smartphone 34 without disconnecting blogs 84 session. The blogs could be from other users too. This again shows how a single set of applications is used while watching television or being mobile, as compared to using applications on a set top box and later synchronizing with mobile devices.

FIG. 20 shows a use case of present invention where user 48 watches television 37 through a smartphone 34 to playout context sensitive blogs associated with television channels. While watching television 37 user 48 associates blogs 84 to television content using a blog association menu 95. When user 48 later watches television channel 76, blogs 84 associated with television channel 76 are automatically pulled up and the combination shown in television 37. This again shows how a single set of applications is used while watching television or being mobile, as compared to using applications on a set top box and later synchronizing with mobile devices.

FIG. 21 shows a use case of present invention where user 48 watches television 37 through a smartphone 34. While watching television 37 user 48 selects regions in television content 96 and creates searchable indexes 97 for these regions 96 and associates with television content being viewed. These indexes are stored in smartphone 34 or a server for future use. Then these search indexes are later recalled by user 48 or another user so that future viewing of the same television content can be more informative and interactive. When user 48 moves away from television 37, user 48 can continue to use software applications 43 in smartphone 34 to improve the indexes 97. This will enable user 48 to get information on particular elements of television content without having content producers modify television content.

This again shows how a single set of applications is used while watching television or being mobile, as compared to using applications on a set top box and later synchronizing with mobile devices.

FIG. 22 shows a use case of present invention where user 48 watches television 37 through a smartphone 34. While watching television 37 user 48 can select background pictures and snapshots from video images 75 and transfer them seamlessly to smartphone 34 to be used as a screensaver or background image 98. When user 48 moves away from television 37, user 48 can continue to use the screensaver or background image 98 on smartphone 34. This again shows how a single set of applications is used while watching television or being mobile, as compared to using applications on a set top box and later synchronizing with mobile devices.

FIG. 23 shows a use case of present invention where user 48 watches television 37 through a smartphone 34. While watching television 37 user 48 can capture soundtracks 99 from video content related to content being viewed and transfer them seamlessly to smartphone 34 to be used as a set of ringtones 100. When user 48 moves away from television 37, user 48 can continue to use the ringtones 100 on smartphone 34. This again shows how a single set of applications is used while watching television or being mobile, as compared to using applications on a set top box and later synchronizing with mobile devices.

FIG. 24 shows a use case of present invention where user 48 watches television 37 through a smartphone 34. While watching television 37 user 48 can blend audio content in smartphone 101 into video content being viewed through an audio content selection menu 102. This enables changing or enhancing background music in a video with music preferred by user 48. Combining audio content shows one kind of interaction with video content but there could also be other forms of interaction such as controlling audio metrics of video being played including quality, frequency and amplitude. This again shows how a single set of applications is used while watching television or being mobile, as compared to using applications on a set top box and later synchronizing with mobile devices.

FIG. 25 shows a use case of present invention where user 48 watches television 37 through a smartphone 34. While watching television 37 user 48 interacts with social networking sites 103 like Facebook and MySpace. When user 48 moves away from television 37, user 48 can continue to interact with the social networking sites 103 on smartphone 34 without disconnecting social networking 103 session. This again shows how a single set of applications is used while watching television or being mobile, as compared to using applications on a set top box and later synchronizing with mobile devices.

FIG. 26 shows a use case of present invention where user 48 watches television 37 through a smartphone 34. While watching television 37 user 48 is engaged in a video conferencing session 104 with a number of users. When user 48 moves away from television 37, user 48 can continue video conferencing session 104 on smartphone 34 without disconnecting video conferencing 104 session. This again shows how a single set of applications is used while watching television or being mobile, as compared to using applications on a set top box and later synchronizing with mobile devices.

FIG. 27 shows a set top box with enhanced interface 105 providing an alternate communication interface with mobile device 106 that provides two way communication between smartphone 34 and set top box 105. A television media provider 74 sends broadcast television signals 36 to the set top box 105 that converts broadcast television signals 36 into digital video content in set top box 107 in a digital video content format in set top box 108. Smartphone 34 runs software applications 43 whose output 49 is captured and sent to set top box 105 using mobile device communication interface 106. This graphics, audio output of software applications 49 is then combined with digital video content 107 in format 108 in set top box 105 to produce a combined digital video content in set top box 109. The combined digital video content 109 is then sent to a television encoder in set top box 110 to make a television compatible encoded signal in set top box 111. After encoding, encoded signal 111 is then sent to television 37 for viewing.

Additionally, the digital video content in format 108 from set top box 105 can be sent to smartphone 34 to software applications 43 to enable further interaction with digital video content in format 108.

This shows an alternate arrangement where software applications in a mobile device can be used to interact with television content without having the mobile device intercept television broadcast signals. Here mobile device only provides the software applications to process media content, and a set top box is used to process television broadcast signals. This arrangement reduces the bill of materials for mobile device while providing the benefit of using a single set of applications. But this method will work only when a set top box is available. In cases where a television is watched directly using a cable input or over the air, it is better for the mobile device to intercept and process television broadcast signals along with providing the software applications that enable interaction.

Advantages

From the description above a number of advantages of this interactive television system that supports mobility become evident:
a) an interactive television system is provided, where state of applications that are used for interactive television is preserved across usage with television and away from television at a mobile device;
b) an interactive television system is provided, that enables efficient transfer of data from a video signal into applications at the mobile device; and
c) an interactive television system is provided, that enables use of mobile device software to interact with television content thus avoiding the need to synchronize application state across two devices such as a set top box and a mobile device.

Conclusion, Ramifications and Scope

Accordingly, the reader-will see that using a single set of applications running at the mobile device to interact with television signals by intercepting television content and combining with output of software running at the mobile device, provides an interactive television system that supports mobility without losing application software state.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A method of providing an interactive television system using a mobile device comprising:
a) providing a input communication module to said mobile device for receiving television signals as input wherein said television signals are signals selected from group consisting of analog broadcast television signals and digital broadcast television signals;
b) receiving said television signals at said input communication module and converting said television signals to digital video content in required digital video content format such that said digital video content can be combined with digital output of software applications running at said mobile device;
c) executing said software applications to interact with said digital video content and capturing output of said software applications;
d) combining said output of said software applications and said digital video content to produce a first combined signal that can be received by a television receiver; and
e) sending said first combined signal to a television receiver to enable a user to view said first combined signal comprising said digital video content and said output of said software applications.

2. The method to provide an interactive television system using a mobile device of claim 1, wherein said mobile device is selected from group consisting of personal digital assistant, mobile phone, smartphone and portable media player capable of receiving said television signals and sending output to a television in real time.

3. The method to provide an interactive television system using a mobile device of claim 1, wherein said digital output of software applications is selected from group consisting of graphics output and audio output.

4. The method to provide an interactive television system using a mobile device of claim 1, further comprising:
a) receiving input from a user into said software applications for said interaction with said digital video content;
b) capturing output related to said input from said software applications;
c) combining said output related to said user input with said first combined signal to produce a second combined signal that can be received by a television receiver; and
d) sending said second combined signal to a television receiver to enable a user to view and interact with the second combined signal comprising said digital video content, said output of said software applications and said output related to said user input.

5. The method to provide an interactive television system using a mobile device of claim 1, wherein said input communication module is comprised of connectivity interfaces selected from group consisting of wired interface and wireless interface.

6. The method to provide an interactive television system using a mobile device of claim 5, wherein said wired interface comprises at least one input jack to receive video signals from video signal sources selected from group consisting of cable television cable, cable television set top box output and satellite television set top box output.

7. The method to provide an interactive television system using a mobile device of claim 5, wherein said wireless interface comprises at least one input interface selected from group consisting of over the air analog video broadcast receiver interface and over the air digital video broadcast receiver interface.

8. The method to provide an interactive television system using a mobile device of claim 1, wherein said software interaction between said software applications and said digital video content is selected from data transfer methods selected from group consisting of bidirectional in memory data transfer method and bidirectional persistent storage based data transfer method.

9. The method to provide an interactive television system using a mobile device of claim 8, wherein said in memory data transfer is selected from in memory data transfer methods selected from group consisting of clipboard based in memory data transfer method and application programming interface based data transfer method.

10. A mobile device providing an interactive television system comprising:
a) a input communication module for receiving television signals as input wherein said television signals are signals selected from group consisting of analog broadcast television signals and digital broadcast television signals;
b) a conversion module to convert said television signals to digitial video content in required digital video content format such that said digital video content can be combined with digital output of software applications running at said mobile device;
c) a set of software applications that can interact with said digital video content;
d) a first combining software module to combine said output of said software applications and said digital video content to produce a first combined signal that can be received by a television receiver; and
e) a output communication module to send said first combined signal to a television receiver to enable a user to view said first combined signal comprising said digital video content and said output of said software applications.

11. The mobile device providing an interactive television system of claim 10, wherein said mobile device is selected from group consisting of personal digital assistant, mobile phone, smartphone and portable media player capable of receiving said television signals and sending output to a television in real time.

12. The mobile device providing an interactive television system of claim 10, wherein said digital output of software applications is selected from group consisting of graphics output and audio output.

13. The mobile device providing an interactive television system of claim 10, further comprising:
a) a user input receiving module to receive input from a user into said software applications for said interaction with said digital video content;
b) a output capturing module to capture output related to said input from said software applications;
c) a second combining module combining said output related to said user input with said first combined signal to produce a second combined signal that can be received by a television receiver; and
d) a output communication module to send said second combined signal to a television receiver to enable a user to view and interact with said second combined signal comprising said digital video content, said output of said software applications and said output related to said user input.

14. The mobile device providing an interactive television system of claim 10, wherein said input communication module is comprised of connectivity interfaces selected from group consisting of wired interface and wireless interface.

15. The mobile device providing an interactive television system of claim 14, wherein said wired interface comprises a input jack to receive video signals from video sources selected from group consisting of cable television input, cable television set top box output and satellite television set top box output.

16. The mobile device providing an interactive television system of claim 14, wherein said wireless interface comprises of an input interface selected from group consisting of analog video broadcast receiver interface, and digital video broadcast receiver interface.

17. The mobile device providing an interactive television system of claim 10, wherein said software interaction between said software applications and said digital video content is selected from data transfer methods selected from group consisting of bidirectional in memory data transfer method and bidirectional persistent storage based data transfer method.

18. The mobile device providing an interactive television system of claim 17, wherein said in memory data transfer is selected from in memory data transfer methods selected from group consisting of clipboard based in memory data transfer method and application programmer interface based data transfer method.

19. A method of providing an interactive television system using a mobile device and a set top box comprising:
a) providing a communication interface to said set top box to provide two way communication with a mobile device, further referred to as mobile device communication interface;
b) receiving television signals at said set top box and converting said television signals to digital video content in set top box in required digital video content format such that said digital video content in set top box can be combined with digital output of software applications running at said mobile device;
c) executing said software applications at said mobile device to interact with said digital video content and capturing output of said software applications;
d) sending said output of said software applications from said mobile device to said set top box using said mobile device communication interface;
e) receiving said output of said software applications from said mobile device at said set top box using said mobile device communication interface;
f) combining said output of said software applications and said digital video content in set top box to produce a combined signal that can be received by a television receiver; and
g) sending said combined signal to a television receiver to enable a user to view said combined signal comprising said digital video content and said output of said software applications.

20. The method of providing an interactive television system using a mobile device and a set top box of claim 1, further comprising:
a) sending said digital video content in set top box that is converted from said television signals to said mobile device using said mobile device communication interface; and
b) receiving said digital video content at said mobile device and invoking said software applications at said mobile device to interact with said digital video content.

21. A set top box device providing an interactive television system comprising:
a) a input communication module for receiving television signals as input;
b) a conversion module to convert said television signals to required digital video content format such that said digital video content can be combined with digital output of software applications running at a mobile device;
c) a mobile device communication interface to provide a two way communication with said mobile device; and
d) a combining module to combine said output of said software applications and said digital video content to produce a combined video signal that can be received by a television receiver;

22. The set top box device providing an interactive television system of claim 21, further comprising:
a) a video signal output sender module to send said combined video signal to said television receiver.
